(19) United States
(12) Patent Application Publication
(10) Pub. No.: US 2007/0195482 A1
(43) Pub. Date: Aug. 23, 2007

(54) Johnsen-Rahbek electrostatic chuck driven with AC voltage

(75) Inventors: Richard Muka, Topsfield, MA (US); Alexander Perel, Danvers, MA (US); Paul Murphy, Reading, MA (US)

Correspondence Address: VARIAN SEMICONDUCTOR EQUIPMENT ASSC., INC., 35 DORY RD., GLOUCESTER, MA, 01930-2297, US

(73) Assignee: Varian Semiconductor Equipment Associates, Inc., Gloucester, MA (US)

(21) Appl. No.: 11/395,744

(22) Filed: Mar. 31, 2006

Related U.S. Application Data
(60) Provisional application No. 60/775,882, filed on Feb. 23, 2006.

(51) Int. Cl. H01T 23/00

(52) U.S. Cl. 361/234

(57) ABSTRACT

An electrostatic chuck includes dielectric layer having at least one region, an electrode associated with the at least one region, and an AC power source configured to provide an AC voltage signal to the electrode. The dielectric property of the dielectric layer is configured to permit a charge migration about the dielectric layer to produce an electrostatic force to attract a workpiece to the dielectric layer when the AC voltage signal is applied to the electrode.

### CROSS REFERENCE TO RELATED APPLICATIONS

This application claims the benefit of U.S. provisional patent application Ser. No. 60/775,882, filed Feb. 23, 2006, the teachings of which are incorporated herein by reference.

### FIELD

This invention relates to electrostatic chucks, and, more particularly, to a Johnsen-Rahbek electrostatic chuck driven with AC voltage.

### BACKGROUND

An electrostatic chuck may be utilized to secure a workpiece to a platen using electrostatic forces. The electrostatic chuck may be utilized in various systems such as in an ion implanter. Ion implantation is a standard technique for introducing conductivity—altering impurities into semiconductor wafers. A desired impurity material may be ionized in an ion source, the ions may be accelerated to form an ion beam of prescribed energy, and the ion beam may be directed at a front surface of the wafer. The energetic ions in the beam penetrate into the bulk of the semiconductor material and are embedded into the crystalline lattice of the semiconductor material to form a region of desired conductivity. The ion beam may be distributed over the wafer area by beam scanning, by wafer movement, or by a combination of beam scanning and wafer movement. It is desirable in the implanter and in other systems to provide a sufficient clamping force to firmly clamp the wafer to the platen. It is also desirable to quickly clamp and release the wafer from the platen.

Electrostatic chucks may generally be classified as either Coulombic or Johnsen-Rahbek types although one chuck may incorporate both types. Each type of chuck may have a dielectric layer positioned between the workpiece and an electrode. A DC voltage may be applied to the electrode. The dielectric layer for the Coulombic chuck is configured to not permit charge migration so that the charge on the Coulombic chuck always resides on the electrode and the workpiece being clamped. In contrast, the dielectric layer for the Johnsen-Rahbek chuck is configured to permit charge migration about the dielectric layer. This leads to an accumulation of charge at the wafer-dielectric interface. Since the distance between the opposite charges is smaller in the Johnsen-Rahbek chuck compared to the Coulombic chuck, clamping pressure in the Johnsen-Rahbek chuck is greater for identical clamping voltages.

The DC voltage applied to the electrode for the Johnsen-Rahbek chuck provides sufficient clamping pressure, but can result in excessive clamp and release times to clamp the workpiece to, and release the workpiece from, the platen. For example, the clamp and release time may take as long as 2-5 seconds, which adversely affects throughput performance. In part to improve the clamp and release times, efforts have been made to provide AC voltage to the electrode of some Coulombic chucks. However, compared to the Coulomb chuck where the image charge is created very quickly, the Johnsen-Rahbek chuck requires the migration or leakage of a sufficient quantity of charge before the clamping force is established. As a result, only DC voltage has conventionally been used with Johnsen-Rahbek chucks.

Accordingly, there is a need for new and improved electrostatic chucks having at least one Johnsen-Rahbek type chuck region driven by AC voltage that can improve clamp and release times of a workpiece, while maintaining the enhanced clamping pressure compared to a Coulombic chuck.

### SUMMARY

According to a first aspect of the invention, an electrostatic chuck is provided. The electrostatic chuck includes a dielectric layer having at least one region, an electrode associated with the at least one region, and an AC power source configured to provide an AC voltage signal to the electrode to cause a charge migration about the dielectric layer that produces an electrostatic force to attract a workpiece towards the dielectric layer.

According to another aspect of the invention, a method is provided. The method includes providing a dielectric layer having at least one region, providing an electrode associated with the at least one region, and providing an AC voltage signal to the electrode to cause a charge migration about the dielectric layer that produces an electrostatic force to attract a workpiece towards the dielectric layer.

According to yet another aspect of the invention, an ion implanter is provided. The ion implanter includes an ion beam generator configured to generate an ion beam and direct the ion beam to a front surface of a wafer, and an electrostatic chuck. The electrostatic chuck includes a dielectric layer having at least on region, an electrode associated with the at least one region, and an AC power source configured to provide an AC voltage signal to the electrode to cause a charge migration about the dielectric layer that produces an electrostatic force to attract the wafer towards the dielectric layer.

### BRIEF DESCRIPTION OF THE DRAWINGS

For a better understanding of the present invention, reference is made to the accompanying drawings, which are incorporated herein by reference and in which:

FIG. 1 is a schematic block diagram of an ion implanter including an ion beam generator and an electrostatic chuck consistent with the present invention;

FIG. 2 is a schematic block diagram of a first embodiment of the electrostatic chuck of FIG. 1;

FIG. 3 is a schematic block diagram of a second embodiment of the electrostatic chuck of FIG. 1;

FIG. 4 is a plot of one AC signal generated by the AC power source of FIGS. 1, 2, or 3;

FIG. 5 is a plot of another AC signal by the AC power source of FIGS. 1, 2, or 3;

FIG. 6 is a plot of clamping pressure versus frequency for the same peak voltage generated by the AC power source of FIGS. 1, 2, or 3; and

FIG. 7 are plots of clamping pressure versus applied voltage for varying frequencies of an AC voltage signal generated by the AC power source of FIGS. 1,2,or 3.

### DETAILED DESCRIPTION

The invention is described herein in connection with an ion implanter that utilizes an electrostatic chuck to support a wafer. However, the invention can be used with other systems that utilize an electrostatic chuck to support a workpiece. Thus, the invention is not limited to the specific embodiments described below.

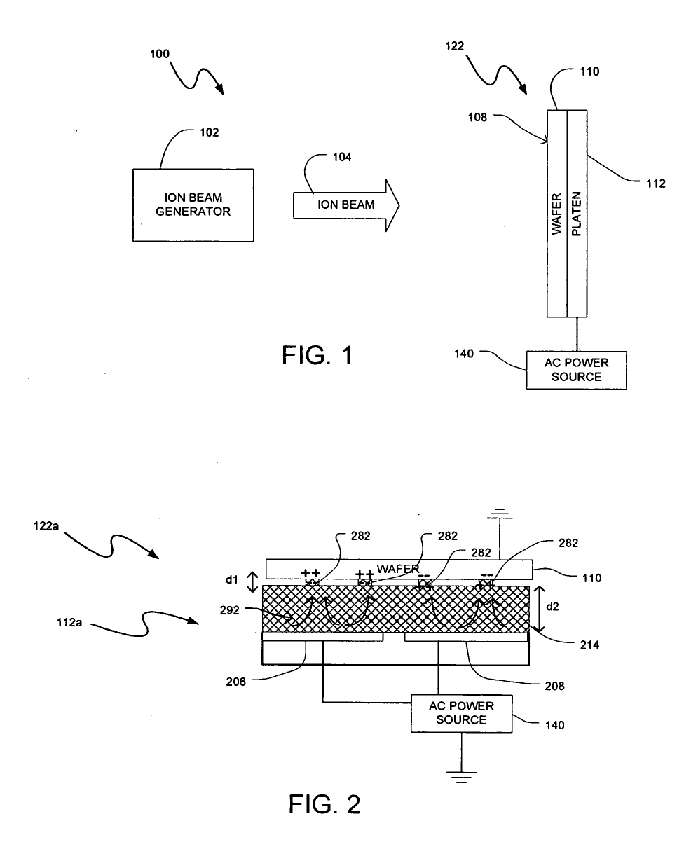

FIG. 1 illustrates a block diagram of an ion implanter 100 including an ion beam generator 102 and an electrostatic chuck 122 consistent with an embodiment of the invention. The ion beam generator 102 may generate an ion beam 104 and direct it towards a front surface 108 of a wafer 110. The ion beam 104 may be distributed over the wafer area by beam scanning, by wafer movement, or by a combination of beam scanning and wafer movement.

The ion beam generator 102 can include various types of components and systems known in the art to generate the ion beam 104 having desired characteristics. The ion beam 104 may be a spot beam or a ribbon beam. The spot beam may have an approximately circular cross-section of a particular diameter depending on the characteristics of the spot beam. The ribbon beam may have a large width/height aspect ratio and may be at least as wide as the wafer 110. The ion beam 104 can be any type of charged particle beam, such as an energetic ion beam used to implant the wafer 110. The wafer 110 can take various physical shapes such as a common disk shape. The wafer 110 can be a semiconductor wafer fabricated from any type of semiconductor material such as silicon or any other material that is to be implanted using the ion beam 104.

The electrostatic chuck 122 may support the wafer 110 and may have at least one region that functions as a Johnsen-Rahbek chuck. The electrostatic chuck 122 may receive an AC voltage signal from the AC power source 140. In response to the AC voltage signal, the region that functions as a Johnsen-Rahbek type chuck may produce an electrostatic force to attract the wafer 110 towards the platen 112.

FIG. 2 is a schematic block diagram of a first embodiment 122a of the electrostatic chuck of FIG. 1. The entire clamping region of the first embodiment of FIG. 2 may function as a Johnsen-Rahbek electrostatic chuck. The Johnsen-Rahbek electrostatic chuck 122a may include the platen 112a. The platen 112a may have a dielectric layer 214 and electrically conductive electrodes 206, 208. Although two electrodes 206, 208 are illustrated, the Johnsen-Rahbek electrostatic chuck 122a may have only one electrode or more than two electrodes.

The electrodes 206, 208 may be electrically connected to the AC power source 140 that supplies an AC voltage signal to each of the electrodes 206, 208. When the AC voltage signal is applied to the electrodes 206, 208, the dielectric layer 214 is configured to permit a charge migration about the dielectric layer 214 that produces an electrostatic force to attract the wafer 110 towards the dielectric layer 214.

The charge migration about the dielectric layer 214 is characteristic of a Johnsen-Rahbek chuck. The charge migration may flow as leakage current through the dielectric layer 214 as indicated by arrows 292. This leads to an accumulation of charge at the interface of the wafer 110 and dielectric layer 214. The accumulated charge may be a positive charge at a front surface of the dielectric layer 214 and an opposing negative charge on the wafer 110. Alternatively, the accumulated charge may be a negative charge at the front surface of the dielectric layer 214 and an opposing positive charge on the wafer 110. Since the distance (d1) between the opposite charges is smaller in the Johnsen-Rahbek chuck compared to the Coulombic chuck (d2), clamping pressure in the Johnsen-Rahbek chuck is greater for identical clamping voltages.

A dielectric property of the dielectric layer 214 may enable the charge migration about the dielectric layer that is characteristic of a Johnsen-Rahbek chuck when the electrodes 206, 208 receive AC voltage from the AC power source 140. The primary dielectric property may be the volume resistivity of the dielectric layer. The volume resistivity for the dielectric layer 214 of the Johnsen-Rahbek chuck 122a may be comparatively less than the volume resistivity for the same dielectric layer 214 of a Coulombic chuck. In one embodiment, the volume resistivity may be less than about 10¹³ Ω-cm to permit charge migration about the dielectric layer 214. In contrast, a volume resistivity of about 10¹⁵ Ω-cm or greater may not permit any charge migration about the dielectric layer 214.

In other embodiments, a relatively low volume resisitivity results in a sheet resistance of about 10¹¹ Ω/sq for a 100 μm thick dielectric layer 214. In contrast, a relatively high volume resistivity for similar materials results in a sheet resistance of about 10¹³ to 10¹⁴ Ω/sq for the same dielectric thickness to prevent the charge migration from flowing. The dielectric layer 214 may be fabricated of various insulator materials including, but not limited to, ceramic materials such as alumina.

Another property of the dielectric layer 214 that may effect the charge migration about the dielectric layer that is characteristic of a Johnsen-Rahbek chuck is the thickness “d2” of the dielectric layer 214. In one instance, the thickness “d2” of the dielectric layer 214 may be relatively thin to decrease the distance that a migrating charge travels from the electrodes 206, 208 towards the wafer 110 as indicated by arrows 292.

Yet another property of the dielectric layer 214 that may affect the charge migration about the dielectric layer that is characteristic of a Johnsen-Rahbek chuck is the surface roughness of the dielectric layer 214 facing the wafer 110. The surface roughness affects the width of any gaps (e.g., even microscopic gaps) between the contact surface of the dielectric layer 214 and the wafer 110. To obtain a large electrostatic force in some instances, the contact surface of the dielectric layer 214 may have a particular surface roughness or embossed surface. In one embodiment, the front surface of the dielectric layer 214 facing the wafer 110 may have a plurality of protrusions to obtain a large electrostatic force at the protrusions 282. In one embodiment, each of the plurality of protrusions 282 may be circular with a diameter of 250 micrometers and a height of 5 micrometers from the top surface of the dielectric layer 214. Alternatively, the contact surface of the dielectric layer 214 may also be relatively smooth.

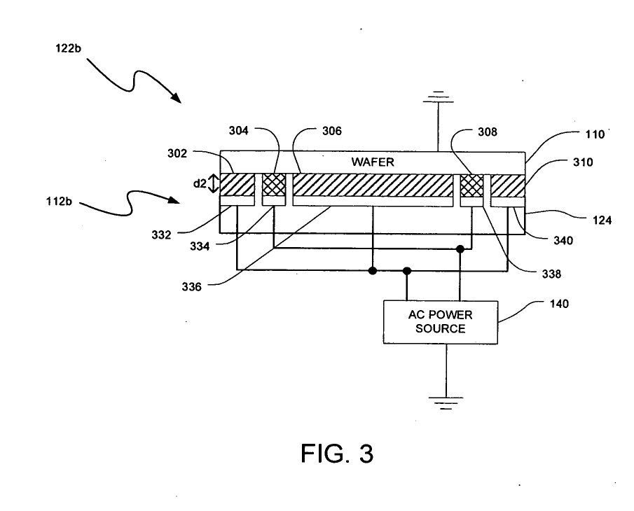

FIG. 3 is a schematic block diagram of a second embodiment 122a of the electrostatic chuck of FIG. 1. Compared to the first embodiment of FIG. 2 where the entire clamping region functions as a Johnsen-Rahbek electrostatic chuck, the chuck 122b of FIG. 3 has one or more regions that function as a Johnsen-Rahbek electrostatic chuck while other regions may function as a Coulombic chuck. The electrostatic chuck 122b may have a plurality of electrodes 332, 334, 336, 338, and 340 corresponding to an associated plurality of dielectric regions 302, 304, 306, 308, 310. Each ofthe dielectric regions 302, 304, 306, 308, 310 may be configured to either allow charge migration (Johnsen-Rahbek regions) or deny charge migration (Coulombic chuck regions). In one instance, the dielectric regions 304, 308 may be configured to permit charge migration to create Johnsen-Rahbek chuck regions and the dielectric regions 302, 306, and 310 may be configured to deny charge migration to create Coulombic chuck regions.

The characteristics of the dielectric regions 302, 304, 306, 308, 310 as earlier detailed (e.g., the volume resisitivity) may be selected to enable creation of either the Johnsen-Rahbek regions or Coulombic regions. The AC power source 140 may supply an AC voltage signal to electrodes 332, 334, 336, 338, and 340. In one instance, the AC power source may supply a separate AC voltage signal to electrodes 334, 338 and to electrodes 332, 336, and 340. The AC voltage signal provided by the AC power source 140 may have a variety of voltage waveforms.

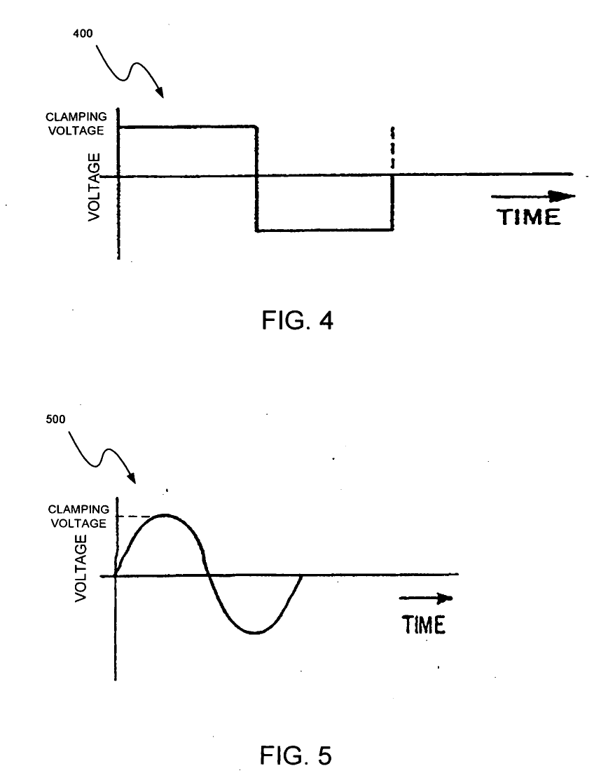

FIG. 4 illustrates a plot 400 of a square wave AC voltage signal waveform that may be provided by the AC power source of FIGS. 1, 2, or 3. FIG. 5 illustrates another plot 500 of a sine wave AC voltage signal waveform that may be provided by the AC power source of FIGS. 1, 2, or 3. The clamping voltage of each AC voltage signal may be defined as the peak voltage of the AC signal. Other AC voltage signal waveforms may also be provided by the AC source 140 and the AC signal is not limited to the square wave and sine wave waveforms illustrated. In addition, both FIGS. 4 and 5 illustrate only one phase for simplicity of illustration. It is to be understood, however, that a plurality of phases of the AC voltage signals may be provided to different electrodes and hence different regions of the electrostatic chuck. In some instance, three phases 120 degrees apart may be applied to three electrodes and in other instances six phases 60 degrees apart may be applied to six electrodes.

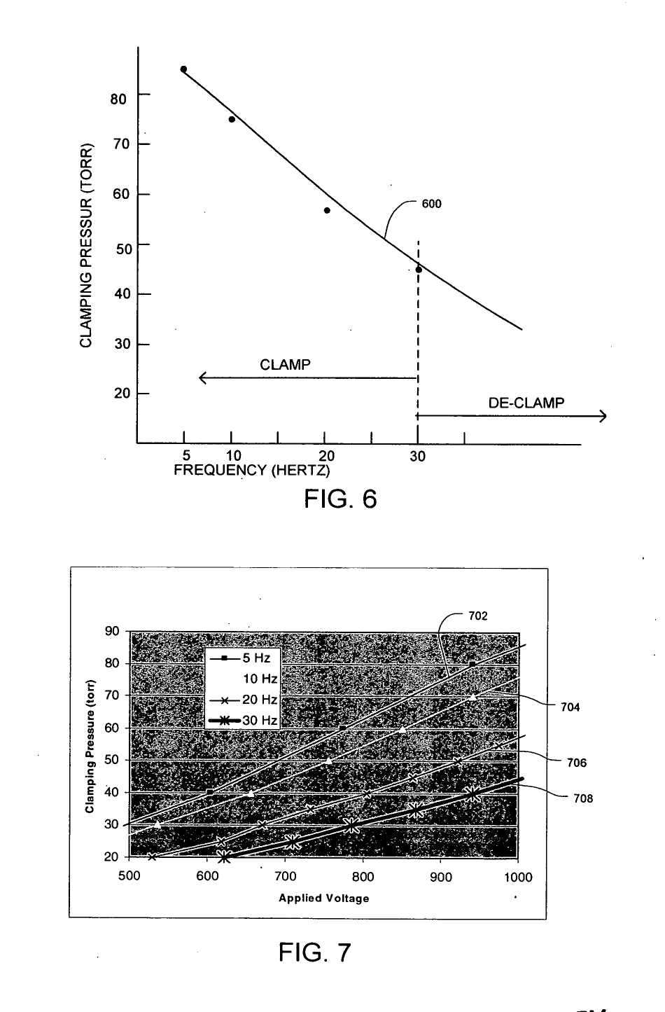

FIG. 6 illustrates a plot 600 of clamping pressure (torr) provided by an electrostatic force when the AC voltage signal is applied to the electrodes of the embodiments of FIGS. 2 and 3 to cause a charge migration about the associated dielectric region. The clamping voltage in FIG. 6 is for a fixed peak voltage of 1,000 volts. As illustrated, the clamping pressure increases when the frequency of the AC voltage signal is decreased. For example, at a frequency of 30 Hertz (Hz), the clamping pressure is about 45 torr and when the frequency is decreased to about 5 Hz, the clamping pressure increases to about 85 torr. This is generally because the lower frequencies allowed a greater amount of charge to migrate through the dielectric layer 214 and accumulate at the dielectric layer-workpiece interface.

The desired clamping pressure may vary with each application and the frequency of the AC voltage signal may be adjusted accordingly to provide the desired clamping pressure. For example, the AC voltage signal may have a frequency less than about 30 Hz at a peak voltage of 1,000 volts to provide a desired clamping pressure. In other embodiments, the AC voltage signal may have a frequency between about 5 Hz and 15 Hz at a peak voltage between about 800 and 1,000 volts to provide the desired clamping pressure.

In yet other instances, a clamping pressure of 50 torr may be sufficient and hence a 20 Hz frequency for a 1,000 volt peak voltage may be adequate. However, other applications may require additional clamping pressure in which case the frequency may be reduced accordingly. Such higher clamping pressure may be needed for high ion beam current applications. High ion beam currents may create large amounts of heat at the wafer. Large amounts of heat can result in uncontrolled diffusion of impurities beyond prescribed limits in the wafer and in degradation of patterned photoresist layers. Therefore, it may be necessary to provide additional wafer cooling which may in turn requires high clamping pressures to withstand the additional cooling pressure.

When it is desired to de-clamp or release the workpiece from the electrostatic clamp, the frequency of the AC voltage signal may be increased from its clamping frequency to quickly de-clamp the workpiece. For example, the AC voltage signal may be less than a threshold, e.g., 30 Hz in FIG. 6, during the clamping of the workpiece. At frequencies below this threshold, e.g., at 20 Hz, the electrostatic chuck may provide the desired clamping pressure. At frequencies above this threshold, the clamping pressure is reduced accordingly to assist with de-clamping or releasing of the workpiece.

In addition, increasing the frequency of the AC voltage signal from its clamping frequency may provide for a faster de-clamp time than simply turning the AC voltage signal off. This is because when the AC voltage signal is simply turned off, the charge that migrated through the dielectric layer and accumulated at the dielectric layer-workpiece interface must be drained away from this interface. The speed at which the charge is drained away is dependent on the RC constant of the dielectric layer where R is the resistance of the dielectric layer and C is the capacitance between the workpiece and the electrodes (dependent at least on the distance (d2) between the workpiece and the electrodes). In contrast to simply letting the charge drain away, an increase in frequency of the AC voltage signal serves to more quickly release the workpiece from the electrostatic clamp because the charge is pulled away from the dielectric layer-workpiece layer. In addition to increasing the frequency of the AC voltage signal, the clamping voltage may also be simultaneously reduced to further decrease release time. In one instance, it was found that a frequency of 15 Hz resulted in sufficient clamping pressure and increasing the frequency resulted in a de-clamp or release time of only 0.070-0.100 seconds.

FIG. 7 illustrates plots of clamping pressure (torr) provided by an electrostatic force when differing AC voltage signals of differing peak voltages and frequencies are applied to electrodes associated with Johnsen-Rahbek regions of the electrostatic chuck of the embodiments of FIGS. 2 or 3. Plot 702 is for a 5 Hz AC voltage signal, plot 704 is for a 10 Hz AC voltage signal, plot 706 is for a 20 Hz AC voltage signal, and finally plot 708 is for a 30 Hz AC voltage signal. As illustrated, the clamping pressure increases as the clamping voltage of the AC voltage signal increases assuming the same frequency. The clamping voltage may be in 800 to 1,200 volt range and may be 1,000 volts peak voltage in one embodiment. This voltage range may provide sufficient clamping force for most applications while higher clamping voltages may cause damage to devices on the wafer. FIG. 7 also illustrates how clamping pressure increases by reducing the frequency of the AC voltage signal assuming the same peak voltage.

Having thus described at least one illustrative embodiment of the invention, various alterations, modifications, and improvements will readily occur to those skilled in the art. Such alterations, modifications, and improvements are intended to be within the scope of the invention. Accordingly, the foregoing description is by way of example only and is not intended as limiting.

What is claimed is:

1. An electrostatic chuck comprising:
a dielectric layer having at least one region;
an electrode associated with said at least one region; and
an AC power source configured to provide an AC voltage signal to said electrode to cause a charge migration about said at least one region of said dielectric layer that produces an electrostatic force to attract a workpiece towards said dielectric layer.

2. The electrostatic chuck of claim 1, wherein a clamping pressure provided by said electrostatic force to said workpiece changes in response to a frequency of said AC voltage signal.

3. The electrostatic chuck of claim 2, wherein said clamping pressure is at a first clamping level for a first frequency of said AC voltage signal having a peak voltage, and wherein said clamping pressure is at a second clamping level for a second frequency of said AC voltage signal having said peak voltage, said first frequency less than said second frequency and said first clamping level greater than said second clamping level.

4. The electrostatic chuck of claim 1, wherein said AC voltage signal has a frequency less about 30 Hertz.

5. The electrostatic chuck of claim 5, wherein said AC voltage signal has a frequency between about 5 Hertz and 15 Hertz and a peak voltage between about 800 volts and 1,000 volts.

6. The electrostatic chuck of claim 1, wherein said dielectric layer has a volume resistivity configured to permit said charge migration in response to said AC voltage signal.

7. The electrostatic chuck of claim 1, wherein said AC voltage signal has a first frequency when said workpiece is attracted to said dielectric layer and a second frequency when said workpiece is released, said second frequency greater than said first frequency.

8. The electrostatic chuck of claim 7, wherein said first frequency is less than or equal to 20 Hertz and said second frequency is greater than or equal to 30 Hertz.

9. A method comprising:
providing a dielectric layer having at least one region;
providing an electrode associated with said at least one region; and
providing an AC voltage signal to said electrode to cause a charge migration about said dielectric layer that produces an electrostatic force to attract a workpiece towards said dielectric layer.

10. The method of claim 9, further comprising varying a frequency of said AC voltage signal, wherein a clamping pressure provided by said electrostatic force to said workpiece changes in response to variations in said frequency.

11. The method of claim 10, further comprising decreasing said frequency from an initial frequency to increase said clamping pressure to attract said workpiece towards said dielectric layer.

12. The method of claim 10, further comprising increasing said frequency from an initial frequency to decrease said clamping pressure to release said workpiece.

13. The method of claim 9, wherein said clamping pressure is at a first clamping level for a first frequency of said AC voltage signal having a peak voltage, and wherein said clamping pressure is at a second clamping level for a second frequency of said AC voltage signal having said peak voltage, said first frequency less than said second frequency and said first clamping level greater than said second clamping level.

14. The method of claim 13, wherein said AC voltage signal has said first frequency when said workpiece is attracted to said dielectric layer and wherein said AC voltage signal has said second frequency when said workpiece is released.

15. The method of claim 14, wherein said first frequency is less than or equal to 20 Hertz and said second frequency is greater than or equal to 30 Hertz.

16. An ion implanter comprising:
an ion beam generator configured to generate an ion beam and direct said ion beam to a front surface of a wafer; and
an electrostatic chuck comprising a dielectric layer having at least one region, an electrode associated with said at least one region, and an AC power source configured to provide an AC voltage signal to said electrode to cause a charge migration about said dielectric layer that produces an electrostatic force to attract said wafer towards said dielectric layer.

17. The ion implanter of claim 16, wherein a clamping pressure provided by said electrostatic force changes in response to a frequency of said AC voltage signal.

18. The ion implanter of claim 17, wherein said clamping pressure is at a first level for a first frequency of said AC voltage signal having a peak voltage, and wherein said clamping pressure is at a second level for a second frequency of said AC voltage signal having said peak voltage, said first frequency less than said second frequency and said first level of said clamping pressure greater than said second level of said clamping pressure

19. The ion implanter of claim 16, wherein said AC voltage signal has a first frequency when said workpiece is attracted to said dielectric layer and wherein said AC voltage signal has a second frequency when said workpiece is released, said second frequency greater than said first frequency.

20. The ion implanter of claim 19, wherein said first frequency is less than or equal to 20 Hertz and said second frequency is greater than or equal to 30 Hertz.
